(19) United States
(12) Patent Application Publication
(10) Pub. No.: US 2011/0017178 A1
(43) Pub. Date: Jan. 27, 2011

(54) CANISTER PURGE CONTROL VALVE CONTROL SYSTEMS

(76) Inventors: William Keith McDonald, Ypsilanti, MI (US); Keith Scott Koller, Grosse lle, MI (US); Eric A. Macke, Ann Arbor, MI (US); Kevin Plymale, Canton, MI (US); Niels Christopher Kragh, Commerce Twp, MI (US); Scott Bohr, Plymouth, MI (US); Eric David Bramson, Ann Arbor, MI (US); Dennis Harrigan, Monroe, MI (US)

Correspondence Address: RICHARD M. SHARKANSKY, 114 TIDE RUN, MASHPEE, MA, 02649, US

(21) Appl. No.: 12/506,283

(22) Filed: Jul. 21, 2009

(51) Int. Cl. F02M 33/02; F16K 31/02

(52) U.S. Cl. 123/520; 251/129.01

(57) ABSTRACT

A purge control valve control system is provided for an internal combustion engine system, comprising: a voltage source having a positive potential and a negative potential; a purge control valve having a solenoid, such solenoid comprising an electrically inductive element, such inductive element having a first terminal coupled to the positive potential of the voltage source; a diode having an anode and a cathode. The control unit includes a transistor having: a control electrode fed by a train of pulses; a first electrode coupled to the negative potential of the voltage source; and a second electrode coupled to a second terminal of the inductive element and to the diode. A train of pulses fed to the control electrode is a pulse width modulated signal and switches the transistor between a conducting condition, wherein current passes between the first electrode and the second electrode, and a non-conducting condition, wherein current is prevented from passing between the first electrode and the second electrode. When the transistor is in the conducting condition current from the voltage source passes through the inductive element and through the first and second electrodes with a potential being produced across the diode to bias the diode to a non-conducting condition and wherein when the transistor switches into the non-conducting condition, energy stored in the inductor when current passes through the inductor during the conducting condition of the transistor, produces a voltage pulse to bias the diode to a conducting condition and such stored energy is dissipated in the inductor as such energy passes as current through the conducting biased diode to the voltage source.

### TECHNICAL FIELD

This disclosure relates generally to canister purge control valve control systems and more particularly to canister purge control valve control systems operated in response to pulse width modulation control signals.

### BACKGROUND AND SUMMARY

As is known in the art, many multi-cylinder internal combustion engines include an evaporative fuel recovery system in which fuel vapors vented from the fuel tank and captured in a carbon canister are drawn into the engine where they are combusted along with fuel delivered by fuel injectors. Such systems can include a purge control valve, which controls the flow rate of canister purge fuel vapors entering the engine. Some purge control valves are controlled by pulse-width modulation signals. Pulse-width modulated valves can be driven by an electrical input signal which is high for a fraction of the signal period and low for the remainder of the signal period. The high portion of the signal is called the on-pulse. The valve opens to allow purge fuel vapors to enter the engine during the on-pulse and closes for the remainder of the signal period. The frequency and duration of the on-pulse determines the average flow rate through the valve. In some canister purge control valve control systems operated in response to pulse width modulation control signals, the canister purge valve (CPV) creates an undesirable clomping sound that is heard in vehicle passenger compartment. One pulse width modulation signal control system is presented in U.S. Patent Publication No. US2004/105209A1.

### SUMMARY

In one embodiment, purge control valve control system is provided having: a voltage source; a purge control valve having an inductor coupled to the voltage source; a transistor having: a control electrode fed by a train of pulses; a first electrode coupled to the voltage source; and a second electrode coupled to the voltage source through the inductor; and a diode connected in parallel with the transistor. Pulse width modulation pulses are fed to the control electrode and switch the transistor between a conducting and a non-conducting condition. When in the conducting condition current from the voltage source passes through the inductor with a potential being produced across the diode to bias the diode to a non-conducting condition and when the transistor switches into the non-conducting condition, energy previously stored in the inductor produces a voltage pulse to bias the diode to a conducting condition and such stored energy is dissipated as such energy passes through the biased diode to the voltage source.

In one embodiment, the diode is connected to the first and second electrodes of the transistor.

In one embodiment, the diode is a Zener diode.

In one embodiment, a purge control valve control system is provided for an internal combustion engine system. The system includes: a voltage source having a positive potential and a negative potential; a purge control valve having a solenoid, such solenoid comprising and electrically inductive element, such inductive element having a first terminal coupled to the positive potential of the voltage source; and a Zener diode having an anode and a cathode and wherein the anode is connected to the negative potential of the voltage source. A control unit comprises: a transistor having: a control electrode fed by a train of pulses; a first electrode coupled to the negative potential of the voltage source; and a second electrode coupled to a second terminal of the inductive element and to the cathode of the diode. A train of pulses fed to the control electrode is a pulse width modulated signal and switches the transistor between a conducting condition, wherein current passes between the first electrode and the second electrode, and a non-conducting condition, wherein current is prevented from passing between the first electrode and the second electrode. When the transistor is in the conducting condition current from the voltage source passes through the inductive element and through the first and second electrodes with a potential being produced across the diode to bias the diode to a non-conducting condition and wherein when the transistor switches into the non-conducting condition, energy stored in the inductor when current passes through the inductor during the conducting condition of the transistor, produces a voltage pulse to breakdown the diode to a conducting condition and such stored energy is dissipated in the inductor as such energy passes as current through the Zener diode to the negative potential of the voltage source voltage source.

In one embodiment, a purge control valve control system is provided having: a voltage source; a purge control valve having an inductor coupled to the voltage source; a first transistor having a first electrode coupled to the voltage source and a second electrode coupled to the voltage source through the inductor; and a second transistor connected in parallel with the inductor. Pulse width modulated pulses are fed to the control electrode of the first transistor and to a control electrode of the second transistor to switch the transistors between a conducting and a non-conducting condition. When the first transistor is in the conducting condition the second transistor is in the non-conducting condition and current from the voltage source passes through the inductor and the first transistor and when the first transistor is in the non-conducting condition the second transistor is in a conducting condition and energy previously stored in the inductor passes through the conducting second transistor.

In one embodiment, the pulse width modulated pulses fed to the control electrodes of the first transistor and second transistors are out of phase one with the other.

In one embodiment, the pulse width modulated pulses are fed to the control electrodes of the first transistor and second transistors with the train of pulses fed to the second transistor having an on-time less than the off-time of the train of pulses fed to the first transistor so that the second transistor enters the non-conducting state before the first transistor enters the conducting state. In this way, the duty cycle of the second transistor could be smaller or larger than the first, depending whether the first duty cycle is more or less than 50%. For example, if the first transistor has 40% duty cycle (on-time), the second transistor could have an on-time (say 55%) less than the 60% off-time of the first transistor. This would stop all current flow and allow the valve to close. Note that in this case, the duty cycle of the second transistor is larger than that of the first transistor.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a diagram of an internal combustion engine system having a purge control valve control system according to the disclosure;

FIG. 2 is a schematic diagram of a purge control valve control system used in the internal combustion engine system according to one embodiment; and

FIG. 2 is a schematic diagram of a purge control valve control system used in the internal combustion engine system according to another embodiment.

Like reference symbols in the various drawings indicate like elements.

### DETAILED DESCRIPTION

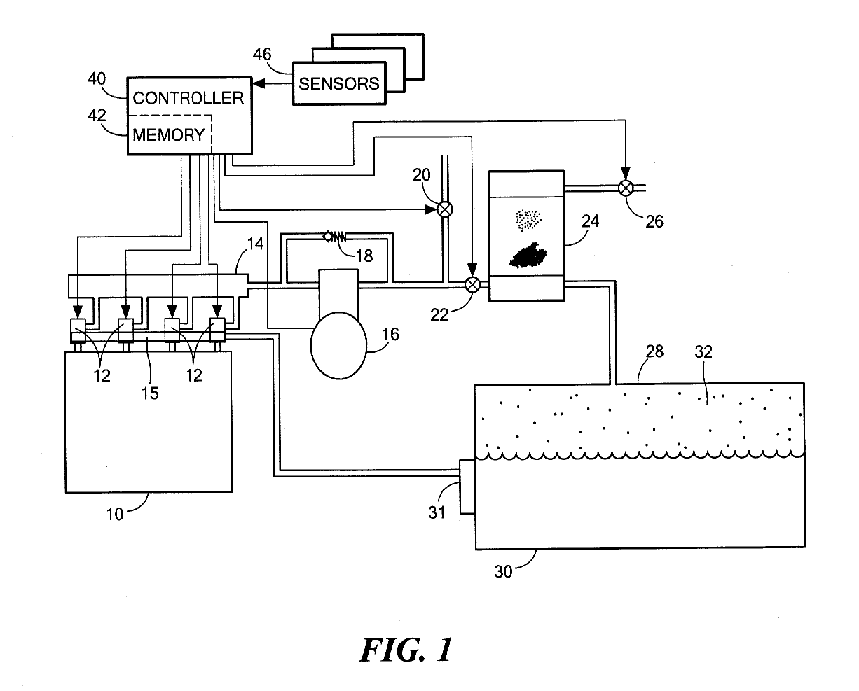

Multicylinder reciprocating internal combustion engine 10, shown in FIG. 1, comprises a plurality of electronically controlled air assisted fuel injectors 12. The air supply side of injectors 12 are in fluid communication with air rail 14 for creating a stratified charge mixture or a homogeneous charge mixture, as desired, in the engine cylinders (not shown). Air rail 14 is in fluid communication in a parallel relationship with the output of compressor 16 and the output of relief valve 18. Fuel rail 15, which is in fluid communication with the fuel supply side of injectors 12, is in fluid communication with fuel tank 28 to receive liquid fuel 30 via fuel delivery system 31 and associated supply lines. The inputs of compressor 16 and relief valve 18 are also in fluid communication with one another. Further, the output of ambient air control valve 20, which could be a simple on/off valve or a linear control type valve, and canister purge valve 22, which could also be a simple on/off valve or a linear control type valve, are in fluid communication with the inputs of compressor 16 and relief valve 18. The input of ambient air control valve 20 is in fluid communication with ambient air. The input of canister purge valve 22 is in fluid communication with canister 24. Canister 24 is in fluid communication with the ambient air through canister vent valve 26. Canister 24 is also in continuous fluid communication with fuel tank 28. Fuel tank 28 contains liquid fuel 30 and air and fuel vapor mixture 32. Fuel tank 28 also comprises a fill tube (not shown) for adding fuel. Alternatively, valve 22 may be in direct communication with tank 28, where no canister is used.

Continuing with FIG. 1, controller 40, having memory device 42, receives information from a plurality of sensors 46 regarding numerous engine operating parameters, such as engine speed, engine load, spark timing, intake manifold absolute pressure, and engine temperature and fuel system operating parameters, such as fuel tank temperature, fuel tank pressure, fuel delivery rate, compressor state, and fuel tank level and other parameters known to those skilled in the art. Controller 40 also controls air assisted fuel injectors 12, compressor 16, ambient air control valve 20, canister purge valve 22, canister vent valve 26, as well as many other actuators such as ignition coils, exhaust gas recirculation valves, and an electronic throttle.

Controller 40, which may comprise a conventional engine control microprocessor known to those skilled in the art, or a stand-alone processor, as desired, is charged with the task of operating engine 10 in both a stratified charge mode and a homogeneous charge mode. When no canister purging and either stratified or homogeneous operation is required, controller 40 operates canister vent valve 26 closed, canister purge valve 22 closed, and ambient air control valve 20 open. Compressor 16 compresses air passing through ambient air control valve 20 to a predetermined pressure regulated by relief valve 18. Compressed air from compressor 16 is delivered to air rail 14 for use by injectors 12 to enhance fuel properties, such as atomization, in the engine cylinders (not shown). At the same time, liquid fuel 30 from tank 28 is delivery to fuel rail 15 to be injected by injectors 12.

When purging of canister 24 is required, controller 40 adjusts canister vent valve 26, canister purge valve 22, and ambient air control valve 20 in response to a predetermined desired vapor purge rate. During purging operation, canister purge valve 22 is open, but canister vent valve 26 and air control valve 20 may be both open, both closed, or one open and one closed. For example, if the desired vapor purge rate is less than the vapor flow rate exiting canister purge valve 22, then ambient air control valve 20 is opened to dilute the vapor flow.

Here the purge control valve 22 is fed a pulse width modulated signal by the controller 40. More specifically, the vapor flow rate percent is controlled by the ratio of the duty cycles of the pulse width modulated signals.

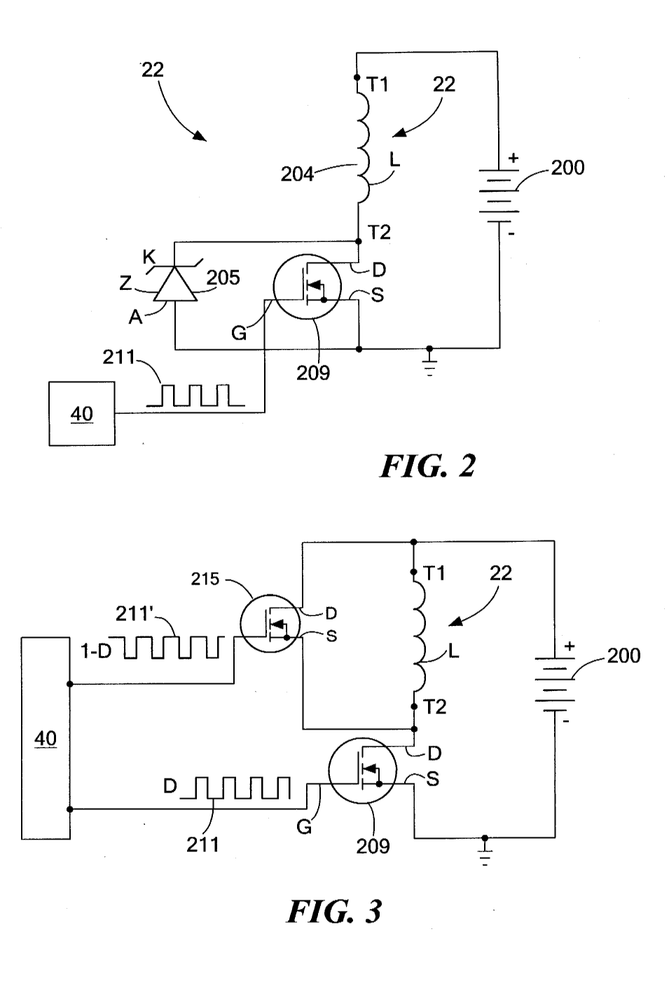

The purge control valve control system 100 for the purge control valve 22 is shown in FIG. 2 to include: a voltage source 200 having a positive potential (+) and a negative potential (−); the purge control valve 22 having a solenoid 204, such solenoid 204 comprising and electrically inductive element, L, such inductive element L having a first terminal T1 coupled to the positive potential (+) of the voltage source 200; a Zener diode 205 having an anode (A) and a cathode (K) and wherein the anode (A) is connected to the negative potential (−) of the voltage source 200; a control unit 208 comprising: a transistor 209, such transistor 209, here an N-channel metal oxide semiconductor (MOS) Field Effect Transistor (FET), having a control electrode, here gate electrode (G) fed by the train of pulses 211, here a pulse width modulated signal from controller 40; a first electrode, here a source electrode (S) coupled to the negative potential (−) of the voltage source 200; and a second electrode, here drain electrode (D) coupled to the second terminal T2 of the inductive element L and to the cathode (K) of the diode 204. As noted above, the train of pulses fed to the control electrode (G), is here a pulse width modulated signal that switches the transistor 209 between a conducting condition, wherein current passes between the first electrode (D) and the second electrode (S), and a non-conducting condition, wherein current is prevented from passing between the first electrode (S) and the second electrode (D). When the transistor 209 is in the conducting condition current from the voltage source 200 passes through the inductive element L and through the first and second electrodes (D, S) with a potential being produced across the diode 205 to bias the diode to a non-conducting condition and when the transistor 209 switches into the non-conducting condition, energy stored in the inductor L when current passes through the inductor L during the conducting condition of the transistor 209, produces a voltage pulse across the Zener diode 205 to breakdown the Zener diode 205 to a conducting condition and such stored energy in the inductor L is dissipated in the resistance in the inductor L as such energy passes as current through the Zener diode 205 to the negative potential of the voltage source. It is also noted that typically, a MOSFET gate will have a resistor to ground in order to bleed off the stored gate voltage resulting from the gate capacitance.

Referring now to FIG. 3, another embodiment is shown. Here a purge control valve control system is provided having: a voltage source 200; a purge control valve having an inductor L coupled the voltage source 200; a first transistor 209 having a first electrode coupled to the voltage source and a second electrode coupled to the voltage source through the inductor; and a second transistor 215 connected in parallel with the inductor L.

More particularly, the inductor L has a first terminal Ti connected the positive potential (+) of the voltage source 200. A first transistor 209 has a first electrode, here a source electrode (S) connected to the negative potential (−) of the voltage source 200 and a second electrode, here a drain electrode (D) connected to the second terminal T2 of the inductor L and has a gate (G) electrode connected by a pulse width modulated signal 211 from the controller 40. Here a second N-channel MOS FET 215 has a first electrode (D) connected to both the first terminal Ti of the inductor L and the positive potential (+) of the voltage source 200 and a second electrode (S) connected to the second terminal T2 of the inductor L. Thus, the second transistor 215 is connected in parallel with the inductor L. The second transistor 215 has a control electrode, here gate (G) fed a pulse width modulated signal 211′ produced by the controller 40. It is noted that the train of pulses 211 is 180 degrees out of phase (i.e., a one pulse time delay) with the pulse train 211′. One implementation is to have a one pulse width time delay between the two pulse trains 211, 211′ as by passing pulse train 211 through a flip flop to generate the pulse train 211′. Thus, there is a one pulse time delay between the two pulse trains 211, 211′. Alternatively, the train of pulses 211′ may have a slightly shorter on time than the off-time of pulse train 211 to allow the valve to close fully before the next cycle.

In any event, pulses are fed to the control electrode (G) of the first transistor 209 and to a control electrode (G) of the second transistor 215 to switch the transistors 209, 215 between a conducting and a non-conducting condition. When the first transistor 209 is in the conducting condition the second transistor 215 is in the non-conducting condition and current from the voltage source 200 passes through the inductor L and the first transistor 209 and when the first transistor 209 is in the non-conducting condition the second transistor 215 is in a conducting condition and energy previously stored in the inductor L passes through the conducting second transistor 215.

A number of embodiments of the disclosure have been described. Nevertheless, it will be understood that various modifications may be made without departing from the spirit and scope of the disclosure. For example other transistor types may be used for the transistors 209 and 215. Accordingly, other embodiments are within the scope of the following claims.

What is claimed is:

1. A purge control valve control system, comprising:
a voltage source;
a purge control valve having an inductor coupled to the voltage source;
a transistor having: a control electrode fed by a train of pulses; a first electrode coupled to the voltage source; and a second electrode coupled to the voltage source through the inductor;
a Zener diode connected in parallel with the transistor.

2. The system recited in claim 1 wherein pulse width modulation pulses are fed to the control electrode and switch the transistor between a conducting and a non-conducting condition.

3. The system recited in claim 2 wherein when in the conducting condition current from the voltage source passes through the inductor with a potential being produced across the diode to bias the diode to a non-conducting condition and when the transistor switches into the non-conducting condition, energy previously stored in the inductor produces a voltage pulse to bias the diode to a conducting condition and such stored energy is dissipated as such energy passes through the biased diode to the voltage source.

4. The purge control valve control system recited in claim 1 wherein the diode is connected to the first and second electrodes of the transistor.

5. The system recited in claim 4 wherein the train of pulses fed to the control electrode is a pulse width modulated signal and switches the transistor between a conducting condition, wherein current passes between the first electrode and the second electrode, and a non-conducting condition, wherein current is prevented from passing between the first electrode and the second electrode.

6. The system recited in claim 5 wherein when the transistor is in the conducting condition current from the voltage source passes through the inductive element and through the first and second electrodes with a potential being produced across the diode to bias the diode to a non-conducting condition and wherein when the transistor switches into the non-conducting condition, energy stored in the inductor when current passes through the inductor during the conducting condition of the transistor, produces a voltage pulse to breakdown the diode to a conducting condition and such stored energy is dissipated in the inductor as such energy passes as current through the Zener diode to the voltage source.

7. The purge control valve control system recited in claim 4 wherein the transistor is a field effect transistor (FET).

8. A purge control valve control system, comprising:
a voltage source;
a purge control valve having an inductor coupled to the voltage source;
a first transistor having a first electrode coupled to the voltage source and a second electrode coupled to the voltage source through the inductor;
a second transistor connected in parallel with the inductor.

9. The system recited in claim 8 wherein pulse width modulated pulses are fed to the control electrode of the first transistor and to a control electrode of the second transistor to switch the transistors between a conducting and a non-conducting condition.

10. The system recited in claim 9 wherein when the first transistor is in the conducting condition the second transistor is in the non-conducting condition and current from the voltage source passes through the inductor and the first transistor and when the first transistor is in the non-conducting condition the second transistor is in a conducting condition and energy previously stored in the inductor passes through the conducting second transistor.

11. The purge control valve control system recited in claim 10 wherein the pulse width modulated pulses fed to the control electrodes of the first transistor and second transistors are out of phase one with the other.

12. The purge control valve control system recited in claim 10 wherein the pulse width modulated pulses fed to the control electrodes of the first transistor and second transistors with the train of pulses fed to the second transistor having an on-time less than the off-time of the train of pulses fed to the first transistor.

13. The purge control valve control system recited in claim 12 wherein the transistors are field effect transistors (FETs).

14. The purge control valve control system recited in claim 13 wherein the FETs are N-channel metal oxide semiconductor (MOS) FETs.

15. A purge control valve control system, comprising:
a voltage source;
a purge control valve having an inductor having a first terminal coupled to a first potential of the voltage source;
a first transistor having a first electrode coupled to a second potential of the voltage source and a second electrode coupled to a second terminal of the inductor;
a second transistor having a first terminal coupled to the first terminal of the inductor and a second electrode coupled to the second terminal of the inductor;
wherein pulse width modulated pulses are fed to the control electrode of the first transistor and to a control electrode of the second transistor to switch the transistors between a conducting and a non-conducting condition; and
wherein when the first transistor is in the conducting condition the second transistor is in the non-conducting condition and current from the voltage source passes through the inductor and the first transistor and when the first transistor is in the non-conducting condition the second transistor is in a conducting condition and energy previously stored in the inductor passes through the conducting second transistor.

16. The purge control valve control system recited in claim 15 wherein the pulse width modulated pulses fed to the control electrodes of the first transistor and second transistors are out of phase one with the other.

17. The purge control valve control system recited in claim 10 wherein pulse width modulated pulses are fed to the control electrodes of the first transistor and second transistors with the train of pulses fed to the second transistor having an on-time less than the off-time of the train of pulses fed to the first transistor.

18. The purge control valve control system recited in claim 17 wherein the transistors are field effect transistors (FETs).

19. The purge control valve control system recited in claim 18 wherein the FETs are N-channel metal oxide semiconductor (MOS) FETs.

20. A purge control valve control system, comprising:
a voltage source;
a purge control valve having an inductor coupled to the voltage source;
a first transistor having a first electrode coupled to the voltage source and a second electrode coupled to the voltage source through the inductor;
a second transistor having a first electrode having a first electrode connected to a first terminal of the inductor and a second electrode connected to a second terminal of the inductor.

21. The purge control valve control system recited in claim 20 wherein pulse width modulated pulses are fed to the control electrodes of the first transistor and second transistors with the train of pulses fed to the second transistor having an on-time less than the off-time of the train of pulses fed to the first transistor.
